(19) United States
(12) Patent Application Publication
(10) Pub. No.: US 2009/0253377 A1
(43) Pub. Date: Oct. 8, 2009

(54) COMMUNICATION RESOURCE SHARING VIA MULTIPLE SYSTEMS

(75) Inventor: Jason A. Trachewsky, Irvine, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/062,948

(22) Filed: Apr. 4, 2008

(51) Int. Cl. H04B 17/00

(52) U.S. Cl. 455/67.11

(57) ABSTRACT

A method begins by monitoring a plurality of channels within a frequency spectrum for transmission patterns. For a given channel of the plurality of channels, the method continues by determining whether a transmission pattern exists and, when the transmission pattern exists, determining at least one likely communication protocol of a plurality of communication protocols based on at least a portion of the transmission pattern. The method continues by determining an idle time of the given channel based on the likely communication protocol. The method continues by transmitting a signal via the given channel during the idle time, wherein the signal is in accordance with a second communication protocol.

### CROSS REFERENCE TO RELATED PATENTS

NOT APPLICABLE

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to communication systems and more particularly to multiple communication systems sharing communication resources.

2. Description of Related Art

Communication systems support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera, communicates directly or indirectly with other wireless communication devices. For direct communications (also known as point-to-point communications), the participating wireless communication devices tune their receivers and transmitters to the same channel or channels (for example, one of the plurality of radio frequency (RF) carriers of the wireless communication system) and communicate over the channel(s).

For indirect wireless communications, each wireless communication device communicates directly with an associated base station (for example, for cellular services) and/or an associated access point (for example, for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (that is, a receiver and a transmitter) or is coupled to an associated radio transceiver (for example, a station for in-home and/or in-building wireless communication networks, RF modem, et cetera). The receiver is coupled to the antenna and includes a low noise amplifier, one or more intermediate frequency stages, a filtering stage, and a data recovery stage. The low noise amplifier receives inbound RF signals via the antenna and amplifies them.

The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

The transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

For both wireless and wireline communication systems, there are several standards specifications with protocols as to how audio, text, video, data, and/or any other type information is to be conveyed within the system. Communication devices that are designed to be compliant with a particular standard (for example, Ethernet 10Base-T, IEEE 802.11b, Bluetooth, et cetera) are able to communication with any other communication devices within the communication system that is compliant with the same standard. For example, wireless communication devices that are compliant with IEEE 802.11b can communicate with each other, provided they are properly registered to the same communication system.

Differing communications standards sometimes use the same communication medium (for example, allocated radio frequency spectrum, wired connections, et cetera) due to a finite amount of communication medium. To illustrate, both Bluetooth and IEEE 802.11b use the 2.4 GHz spectrum. As long as communication systems that are compliant with differing standards share a communication medium and do not physically overlap, the systems can operate without interference from each other.

When the communication systems do physically overlap, however, they will interfere with each other and degrade the performance of both systems. For example, when a Bluetooth piconet physically overlaps with an IEEE 802.11b local area network, simultaneous use of the 2.4 GHz spectrum will cause interference that will most likely cause both transmissions to fail.

To help reduce this problem, communication devices have been developed to be compliant with multiple standards that have different protocols for a share communication medium. For example, wireless communication devices have been developed that are compliant with both Bluetooth and IEEE 802.11(a), (b), (g), and/or (n). In such devices, the Medium Access Control (MAC) layer of one protocol communications with the MAC layer of another protocol to avoid simultaneous use of the shared communication medium.

While this substantially reduces simultaneous use of a shared communication medium on a device-by-device basis, it does little to reduce simultaneous use on a communication system level. For example, if a first communication device desires to use the shared communication medium in accordance with a first protocol, it will block its use of a second protocol for the duration of the use per the first protocol; however, a second communication device may concurrently desire to use the shared communication medium in accordance with the second protocol. Because the protocols are different, the first device will obtain access of the share communication medium in accordance with the first protocol and the second device will obtain access of the shared communication medium in accordance with the second protocol. With both devices concurrently accessing the shared communication medium, their transmissions will again interfere with each other, causing at least one of the transmissions to fail.

Further, with increasing numbers of wireless communication devices in a communications system, when the channels of a frequency spectrum are congested with traffic from multiple devices using multiple specification protocols, transmission interference occurs even with transmissions having relatively little, though important, data content. An example of such interference is delay in being able to transmit while waiting for channels to clear of traffic. Another example is the delay of having to compete with other communication devices for the opportunity to transmit.

Therefore, a need exists for sharing communication resources (e.g., channels) of a frequency spectrum.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a wireless communication system in accordance with the present invention;

FIG. 2 is a diagram of an example of a wireless communication pattern in accordance with the present invention;

FIG. 3 is a diagram of another example of a wireless communication pattern in accordance with the present invention;

FIG. 4 is a schematic block diagram of an embodiment of a wireless communication device in accordance with the present invention;

FIG. 5 is a diagram of an example of a wireless communication in accordance with the present invention;

FIG. 6 is a logic diagram of a method of determining transmission patterns in accordance with the present invention;

FIG. 7 is a diagram of an example of analog transmission patterns in accordance with the present invention;

FIG. 8 is a diagram of an example of digital transmission patterns in accordance with the present invention;

FIG. 9 is a logic diagram of a method of determining a number of concurrent signals in accordance with the present invention; and

FIG. 10 is a logic diagram of a method of sharing communication resources in accordance with the present invention.

### DETAILED DESCRIPTION OF THE INVENTION

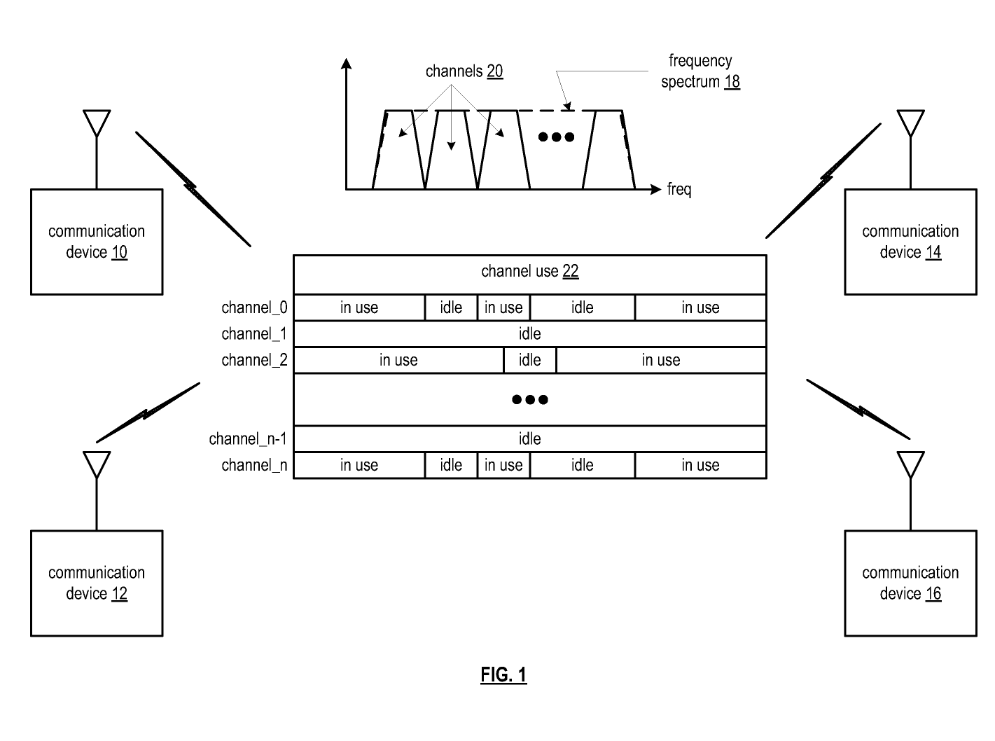

FIG. 1 is a schematic block diagram of an embodiment of a wireless communication system that includes a plurality of communication devices 10-16. Each of the communication devices 10-16 may be infrastructure equipment (e.g., a base station for cellular systems, an access point for wireless local area network systems, a bridge, a relay, a gateway, a network card, etc.) or end-user equipment (e.g., a cell phone, a personal computer, a laptop computer, a personal digital assistance, a station, a headset, a printer, a fax machine, a monitor, etc.). The communication devices 10-16 may use the same communication protocol (e.g., Bluetooth, IEEE 802.11, GSM, EDGE, GPRS, WCDMA, HSDPA, HSUPA, ECMA, 802.11.3, NGMS wireless HD, IEEE 802.11 VHT, variations thereof, extensions thereof, new implementations thereof, etc.) within a given frequency spectrum 18 (e.g., 900 MHz, 2.4 GHz, 5 GHz, 19 GHz, 60 GHz, etc.) or different communication protocols.

In this example embodiment, a frequency spectrum 18, which may be licensed or unlicensed, is divided into a plurality of channels 20 (e.g., eleven to fourteen channels for IEEE 802.11(a) or (g); 4 channels at 2.16 GHz spacing for 60 GHz spectrum; twenty-three or seventy-nine channels for Bluetooth). Each channel 20 may support a communication between two or more communication devices 10-16 using one of a plurality of wireless communication protocols (e.g., Bluetooth, IEEE 802.11, GSM, EDGE, GPRS, WCDMA, HSDPA, HSUPA, ECMA<802.11.3, NGMS wireless HD, IEEE 802.11 VHT, variations thereof, extensions thereof, new implementations thereof, etc.). While a channel may be supporting a communication, there is times when the channel is in use and times when the channel is idle.

For example, the channel use pattern 22 indicates that channel_0 and channel_n have the same channel use and idle pattern. The channel use pattern 22 further shows that channel_1 and channel_n-1 are idle for the duration of this example time frame, which may range for a few milli-seconds to tens of seconds. Channel_2 has a different use and idle pattern than the pattern of channel_0 and channel_n.

In an embodiment, one or more of the communication devices 10-16 monitor the channel usage 22 to determine (i.e., predict) when idle times will most likely occur on the channel based on the channel's transmission pattern. Once the idle times are known, the communication device 10-16 may transmit within the idle times using another communication protocol (e.g., a high data rate scheme, a short messaging scheme, etc.) with minimal interference of the communication on the channel. Such an idle time communication may occur on a single channel or multiple channels. In this manner, the communication resources (e.g., channels) of a frequency spectrum are shared among a plurality of communication systems (e.g., systems with differing protocols) with greater spectral usage and minimal interference.

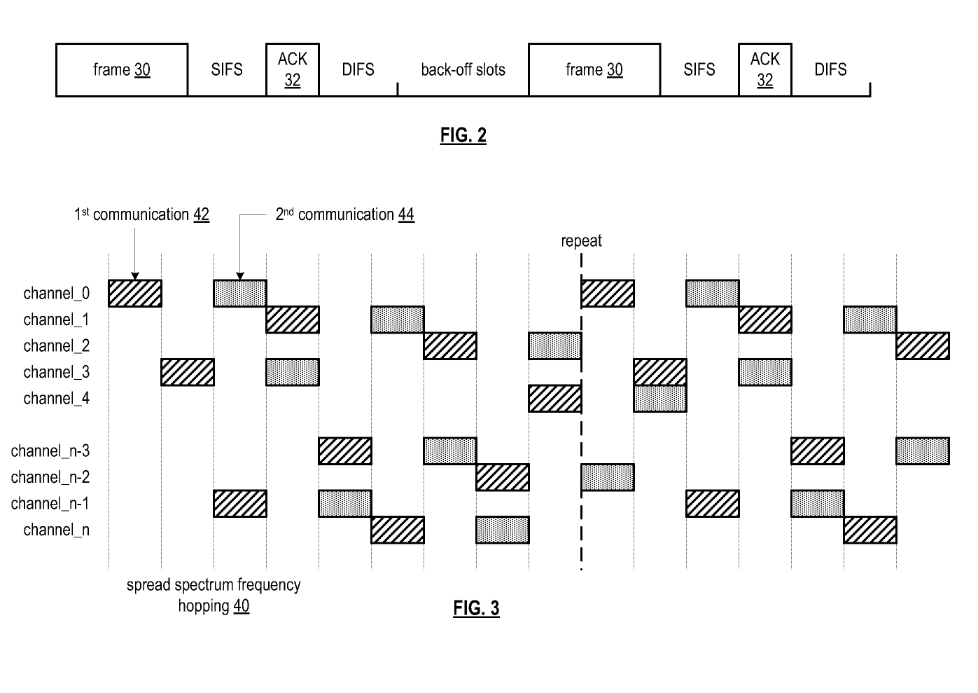

FIG. 2 is a diagram of an example of a wireless communication pattern (e.g., an IEEE 802.11 (a), (g), etc.) that includes a plurality of repetitive elements. For instance, the elements include a frame 30, a SIFS (short interframe spacing) section, an acknowledgement field 32, a DIFS (distributed interframe spacing) section, and one or more back-off slots. This pattern of frame 30, SIFS, ACK 32, DIFS, and back-off slots repeat. As such, the pattern of an IEEE 802.11 communication can be fairly easily recognized, where the channel is idle during the SIFS, DIFS, and back-off slots. Thus, the idle times may be used for another communication as discussed with reference to FIG. 1.

FIG. 3 is a diagram of another example of a wireless communication pattern that includes spread spectrum frequency hopping 40 as may be used by one or more of the plurality of communication protocols (e.g., Bluetooth, CDMA, WCDMA, etc.). In this example, two communications 42 and 44 share the communication resources (e.g., channels 0-n). Each communication 42 and 44 may employ a pseudo random frequency hopping pattern that can be determined and followed. Once the frequency hopping pattern is identified, the idle times may be used for another communication as discussed with reference to FIG. 1.

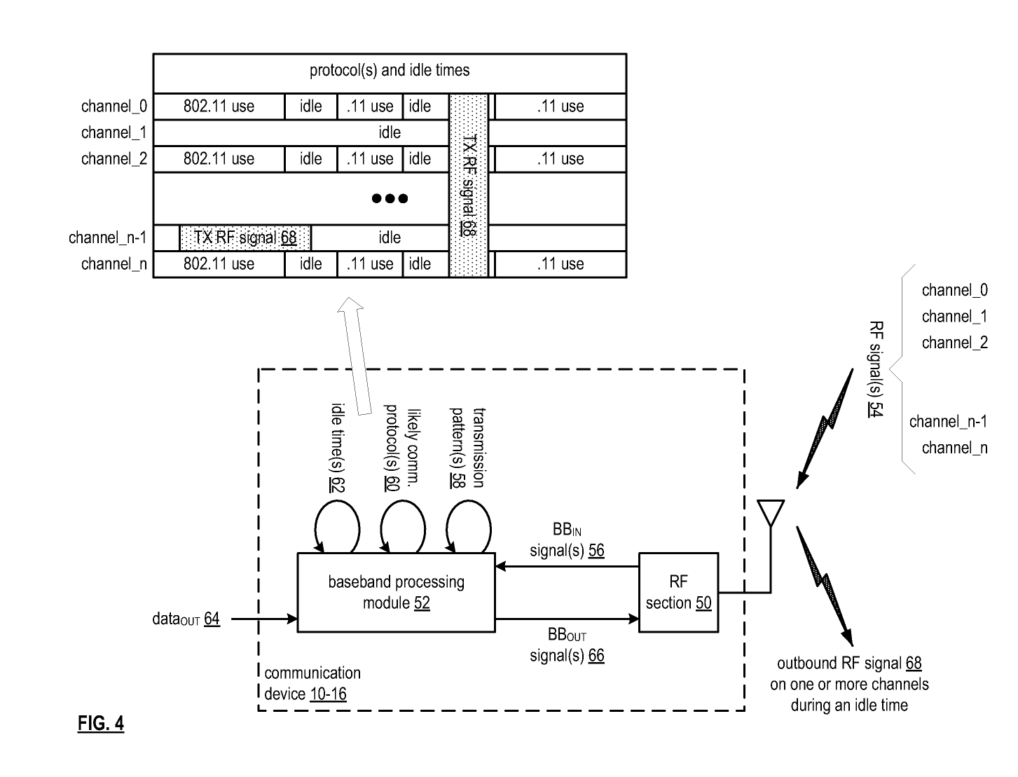

FIG. 4 is a schematic block diagram of an embodiment of a wireless communication device 10-16 that include a radio frequency (RF) section 50 and a baseband processing module 52. The baseband processing module 52 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 52 may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 52 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-10.

The communication device 10-16 functions in an initialization phase and an operational phase. In the initialization phase, the communication device 10-16 determines the channel use patterns 22 of the various channels 20 in the frequency spectrum. When the channel use patterns 22 are determined, the communication device 101-6 switches to the operational phase where, during idle times, the communication device 10-16 transmits a signal via one or more channels. Note that the communication device 10-16 may periodically or randomly switch back to the initialization phase to update the channel use pattern 22.

In the initialization phase, the RF section 50 receives at least one RF signal 54 via at least one of the plurality of channels 20 (e.g., channel 0-n) within the frequency spectrum 18. The RF section 50, which may includes a low noise amplifier, a channel selection filter, a down conversion module, a baseband or low intermediate frequency filter and/or gain stage, and an analog to digital conversion module, converts the at least one RF signal 54 into at least one inbound baseband signal 56. Note that for each channel supporting a communication, the RF section 54 converts the corresponding RF signal 54 into a baseband signal 56. For example, if three channels are supporting RF signals, then the RF section 50 produces three baseband signals 56, which may have a carrier frequency of DC to a few MHz.

The baseband processing module 52 determines at least one transmission pattern 58 from the at least one inbound baseband signal 56. In an embodiment, the baseband processing module 52 may perform one or more of a fast Fourier transform (FFT) function, demapping, deinterleaving, decoding, descrambling, etc. to produce an inbound signal. The baseband processing module 52 may further include a match filter to correlate the inbound signal, or a portion thereof (e.g., the preamble and/or the header) with the signal “foot print” of a known protocol. Alternatively, the baseband processing module 52 may determine the energy present on each of the channels to establish the transmission pattern (e.g., have a signal energy indicates use and very low signal energy (e.g., less than −90 dBm) indicates an idle time).

The baseband processing module 52 then determines at least one likely communication protocol 60 of a plurality of communication protocols based on at least a portion of the transmission pattern 58. As shown in the examples of FIGS. 2 and 3, specific communication protocols have specific transmission patterns (e.g., presence and absence of signals). Thus, once the transmission pattern is identified, it can be mapped to a particular communication protocol. Note that for a given channel, if the pattern cannot be readily determined, the channel is flagged as not available.

The baseband processing module 52 then determines the idle time 63 of the at least one of the plurality of channels based on the likely communication protocol 60. The table of protocols and idle times per channel of FIG. 4 provides an example of the determinations made by the baseband processing module 52. In this example, channels 0, 2, and n are supporting 802.11 communications and channels 1 and n-1 are idle. Having generated this information, the baseband processing module 52 can transition the communication device 10-16 into the operational phase.

In the operational phase, the baseband processing module 52 converts, during the idle time of one or more channels, outbound data 64 (e.g., voice, audio, video, text, short message, etc.) into the outbound baseband signal 66 in accordance with a second communication protocol (e.g., a protocol different than the one or more protocols being used within the frequency spectrum). The new communication protocol may define a data modulation scheme (e.g., BPSK, QPSK, FSK, GSM, ASK, QAM, etc.), a channel use scheme (e.g., TDMA, FDMA, CDMA, OFDM, etc.), a scrambling scheme, an encoding scheme, a data puncture scheme, an interleaving scheme, space-time-frequency encoding, a beamforming scheme, a frequency to time domain conversion, transmit power level, number of transmit antennas, number of receive antennas, etc.

The RF section 50 converts the outbound baseband signal 66 into an outbound RF signal 68 in accordance with the second communication protocol. The RF section 50 then transmits, during an idle time, the outbound RF signal 58 via at least one idle channel of a plurality of channels within a frequency spectrum. As an example, the RF section 50 may transmit the RF signal 68 on channel n-1 at any time, since the channel is idle. As another example, the RF signal 68 may be transmitted on all, or some of, the channels during concurrent idle times.

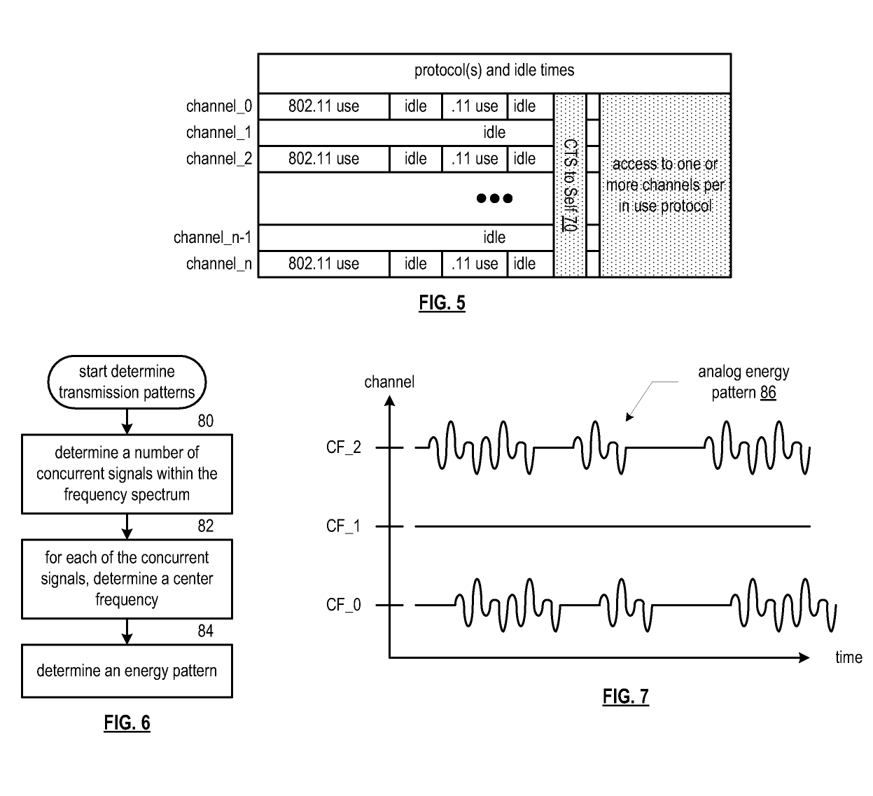

FIG. 5 is a diagram of an example of channel usages for at least one wireless communication. In this example, channels 0, 2, and n are supporting an IEEE 802.11 communication and channels 1 and n-1 are not used (i.e., are idle). To extend the use of one or more channels, a communication device 10-16 may utilize the likely communication protocol to obtain access to the one or more channels. For instance, a communication device 10-16 may transmit, in accordance with the IEEE 802.11 protocol, a clear to self (CTS) message 70 during an idle time of one or more channels. The devices utilizing channels 0, 2, or n, will recognize the CTS message 70 and not use the one or more channels for a given period of time. Thus, the communication device 10-16 can reserve one or more channels within the frequency spectrum using the protocol, or protocols, supported by the channels.

FIG. 6 is a logic diagram of a method of determining transmission patterns that begins at step 80 where the communication device determines a number of concurrent signals (e.g., a signal conveyed via a channel) within the frequency spectrum. Examples of the determining concurrent signals will be further discussed with reference to FIGS. 7-9.

The method continues at step 82 where the communication device determines a center frequency for each of the concurrent signals. The method continues at step 84 where the communication device determines, in accordance with the center frequency, an energy pattern of at least a portion of the at least one of the concurrent signals to produce the transmission pattern.

FIG. 7 is a diagram of an example of analog transmission patterns 86 for two signals; one on center frequency (CF) two and another on center frequency (CF) zero. As is also shown, there is no signal energy on center frequency one. Such energy may be detected uses RSSI or other type of signal strength indication.

FIG. 8 is a diagram of an example of digital transmission patterns 88 for two signals; one on center frequency (CF) two and another on center frequency (CF) zero. As is also shown, there is no signal energy on center frequency one. Such energy may be detected uses a digital matched filter, an FFT and corresponding energy detector per channel. For example, the energy detector may be done using a moving average of magnitude squared.

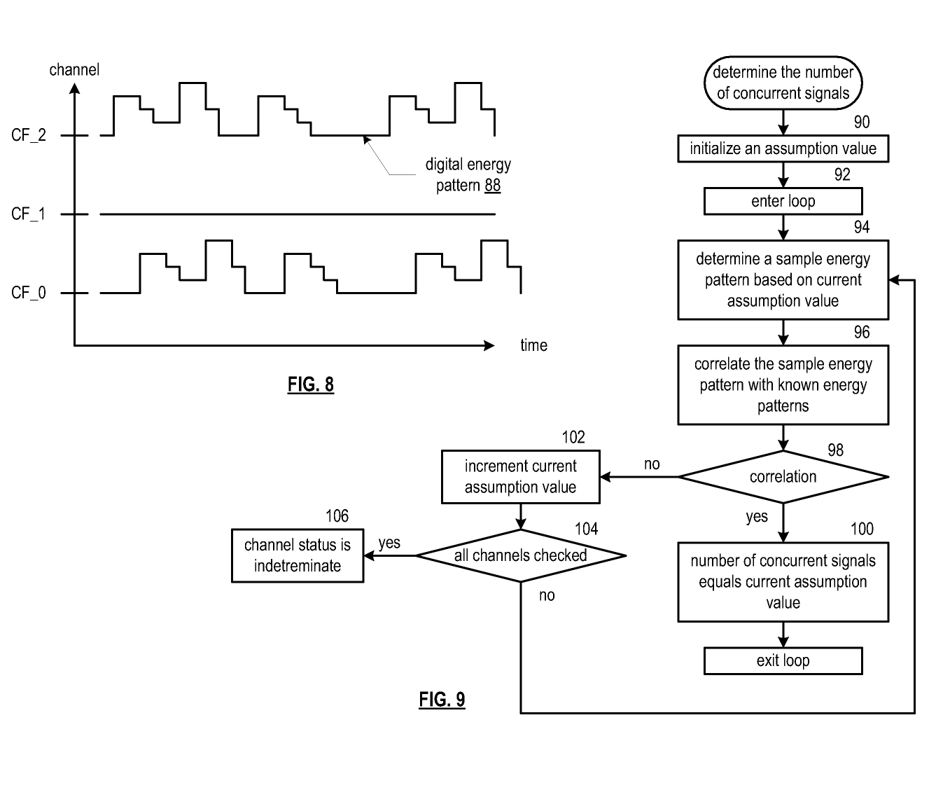

FIG. 9 is a logic diagram of a method of determining a number of concurrent signals that begins at step 90 where the communication device 10-16 initializes an assumption value (e.g., how many signals are present on the plurality of channels). In an embodiment, the assumption value is initialized to one. The method continues at step 932 where the communication device 10-16 enters a loop. Within the loop, the method proceeds to step 94 where the communication device 10-16 determines a sample energy pattern based on an assumption that the concurrent signals includes a number of signals equal to the assumption value or an incremented assumption value. For example, if the assumption value is one, then the sample energy pattern (e.g., the pattern of FIGS. 7 and/or 8) is assumed to be from one signal.

The method then proceeds to step 96 where the communication device 10-16 correlates the sample energy pattern with a plurality of known energy patterns. The plurality of known energy patterns correspond to the plurality communication protocols. In an embodiment, the correlation may be done by a matched filter that filters the sample energy pattern with respect to the plurality of known energy patterns. In another embodiment, the correlation may be done by determining a moving average of magnitude squared of the sample energy pattern with respect to each channel within the frequency spectrum. With respect to the examples of the FIGS. 7 and 8, a single energy pattern assumption for the two signals would not correlate with one of the known energy patterns.

The method branches at step 98 to step 100 when the sampled energy pattern correlates with one of the known patterns and branches to step 102 when the sample energy pattern does not correlate with one of the known patterns. At step 102, the assumption value is incremented (e.g., from 1 to 2). The method then proceeds to step 104 where the communication device 10-16 determines whether all of the channels have been checked (e.g., the assumption value is greater than the number of channels in the frequency spectrum). When all of the channels has been checked, the method concludes at step 106, to indicate that status of the channel or channels is/are indeterminate (i.e., cannot recognize a pattern and thus cannot predict idle times).

If all of the channels have not been checked (i.e., the assumption value is less than or equal to the number of channels in the frequency spectrum), the method repeats at step 94. For the second pass through the loop, the assumption value may be 2. In this instance, when the steps 96 and 98 are performed upon the example signals of FIGS. 7 and 8, the two signals will correlate with a known energy pattern. When this occurs, the method continues at step 100, where communication device 10-16 determines that the number of signals equals the current assumption value and the loop is exited.

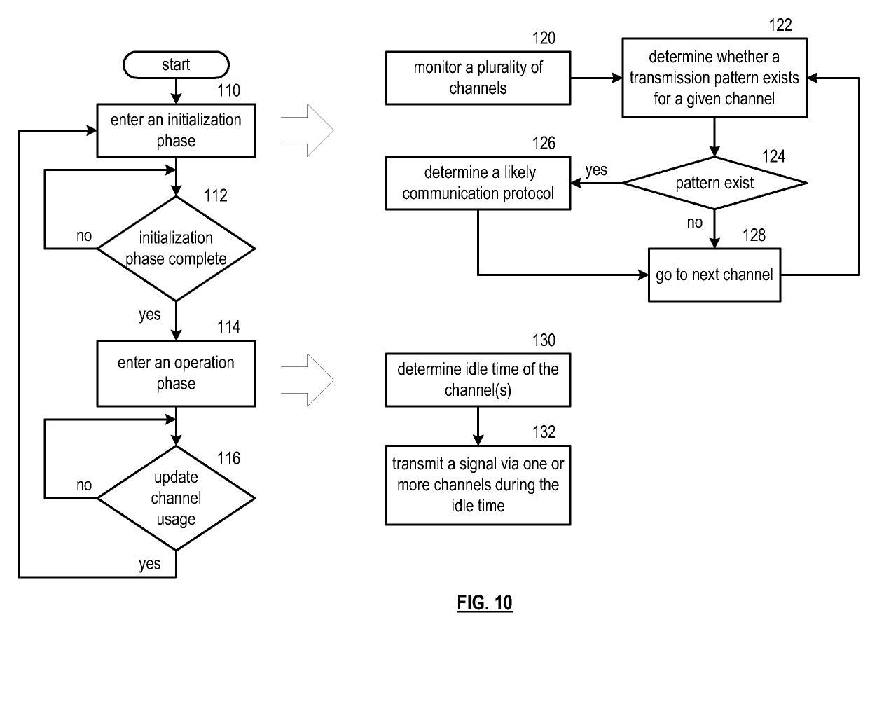

FIG. 10 is a logic diagram of a method of sharing communication resources by a communication device that begins at step 110 where the communication device enters an initialization phase 110. In the initialization phase, the communication device 10-16 monitors, at step 120, a plurality of channels within a frequency spectrum for transmission patterns. The initialization phase continues at step 122 where the communication device 10-16 determines whether a transmission pattern exists for a given channel of the plurality of channels. The initialization phase branches at step 124 to step 126 when the transmission pattern exists and to step 128 when the transmission pattern does not exist.

At step 126, the communication device 10-16 determines at least one likely communication protocol of a plurality of communication protocols based on at least a portion of the transmission pattern (e.g., the preamble, the header, and/or the data fields). At step 128, the communication device 10-16 goes to the next channel and repeats the initialization process (e.g., steps 120-128).

Returning to the main flow diagram, the method continues at step 112 where the communication device 10-16 determines whether the initialization phase is complete. If not, the process repeats at step 110. If yes, the method continues at step 114 where the communication device 10-16 enters the operational phase.

In the operational phase, the communication device determines an idle time of the given channel based on the likely communication protocol. The communication device 10-16 may do this for each channel within the frequency spectrum. The operational phase then continues at step 132 where the communication device 10-16 transmits a signal via the given channel during the idle time, wherein the signal is in accordance with a second communication protocol. The main flow diagram continues at step 116 where the communication device determines whether to update the channel usage information. If not, the method remains in the operational phase. If yes, the method repeats at the initialization phase.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A method comprises:
monitoring a plurality of channels within a frequency spectrum for transmission patterns;
for a given channel of the plurality of channels:
determining whether a transmission pattern exists;
when the transmission pattern exists, determining at least one likely communication protocol of a plurality of communication protocols based on at least a portion of the transmission pattern;
determining an idle time of the given channel based on the likely communication protocol; and
transmitting a signal via the given channel during the idle time, wherein the signal is in accordance with a second communication protocol.

2. The method of claim 1 further comprises:
utilizing the likely communication protocol to obtain access to the given channel.

3. The method of claim 1, wherein the determining whether the transmission pattern exists for the given channel comprises:
determining a number of concurrent signals within the frequency spectrum, wherein at least one of the concurrent signals is transmitted via the given channel;
for each of the concurrent signals, determining a center frequency; and
determining, in accordance with the center frequency, an energy pattern of at least a portion of the at least one of the concurrent signals to produce the transmission pattern.

4. The method of claim 3, wherein the determining the number of concurrent signals comprises:
initializing an assumption value;
entering a loop, wherein the loop includes:
determining a sample energy pattern based on an assumption that the concurrent signals includes a number of signals equal to the assumption value or an incremented assumption value;
correlating the sample energy pattern with a plurality of known energy patterns, wherein the plurality of known energy patterns correspond to the plurality communication protocols;
when the sample energy pattern correlates with one of the plurality of known energy patterns, determining the number of concurrent signals equals the assumption value or the incremented assumption value and exiting the loop;
when the sample energy pattern does not correlate with at least one of the plurality of known energy patterns, incrementing the assumption value or the incremented assumption value to produce the incremented assumption value; and
when the incremented assumption value does not exceed a number of channels within the frequency spectrum, repeating the loop based on the incremented assumption value.

5. The method of claim 4, wherein the correlating the sample energy pattern with a plurality of known energy patterns comprises at least one of:
matched filtering the sample energy pattern with the plurality of known energy patterns; and
determining a moving average of magnitude squared of the sample energy pattern with respect to each channel within the frequency spectrum.

6. The method of claim 1 further comprises:
determining a plurality of idle times corresponding to the plurality of channels based on a likely communication protocol for each of the plurality of channels;
determining concurrent idle times of at least two of the plurality of idle times; and
transmitting a second signal via at least two corresponding ones of the plurality of channels during the concurrent idle times, wherein the signal is formatted in accordance with another communication protocol.

7. The method of claim 1, wherein the frequency spectrum comprises at least one of:
a licensed frequency spectrum; and
an unlicensed frequency spectrum.

8. A communication device comprises:
a radio frequency (RF) section coupled to:
convert an outbound baseband signal into an outbound RF signal in accordance with a second communication protocol;
transmit, during an idle time, the outbound RF signal via at least one idle channel of a plurality of channels within a frequency spectrum;
receive at least one RF signal via at least one of the plurality of channels within the frequency spectrum; and
convert the at least one RF signal into at least one inbound baseband signal; and
a baseband processing module coupled to:
determine at least one transmission pattern from the at least one inbound baseband signal;
determine at least one likely communication protocol of a plurality of communication protocols based on at least a portion of the at least one transmission pattern;
determine the idle time of the at least one of the plurality of channels based on the likely communication protocol; and
during the idle time, convert outbound data into the outbound baseband signal in accordance with the second communication protocol.

9. The communication device of claim 8, wherein the baseband processing module further functions to:
utilize the likely communication protocol to obtain access to the at least one of the plurality of channels.

10. The communication device of claim 8, wherein the baseband processing module further functions to determine whether the transmission pattern exists for the given channel by:
determining a number of concurrent signals within the frequency spectrum, wherein at least one of the concurrent signals is transmitted via the given channel;
for each of the concurrent signals, determining a center frequency;
determining, in accordance with the center frequency, an energy pattern of at least a portion of the at least one of the concurrent signals to produce the transmission pattern.

11. The communication device of claim 10, wherein the baseband processing module further functions to determine the number of concurrent signals by:
initializing an assumption value;
entering a loop, wherein the loop includes:
determining a sample energy pattern based on an assumption that the concurrent signals includes a number of signals equal to the assumption value or an incremented assumption value;
correlating the sample energy pattern with a plurality of known energy patterns, wherein the plurality of known energy patterns correspond to the plurality communication protocols;
when the sample energy pattern correlates with one of the plurality of known energy patterns, determining the number of concurrent signals equals the assumption value or the incremented assumption value and exiting the loop;
when the sample energy pattern does not correlate with at least one of the plurality of known energy patterns, incrementing the assumption value or the incremented assumption value to produce the incremented assumption value; and
when the incremented assumption value does not exceed a number of channels within the frequency spectrum, repeating the loop based on the incremented assumption value.

12. The communication device of claim 11, wherein the baseband processing module further functions to correlating the sample energy pattern with a plurality of known energy patterns by at least one of:
matched filtering the sample energy pattern with the plurality of known energy patterns; and
determining a moving average of magnitude squared of the sample energy pattern with respect to each channel within the frequency spectrum.

13. The communication device of claim 8, wherein the baseband processing module further functions to:
determine a plurality of idle times corresponding to the plurality of channels based on a likely communication protocol for each of the plurality of channels;
determine concurrent idle times of at least two of the plurality of idle times; and
convert the outbound data into the outbound baseband signal in accordance with the second communication protocol for transmission via at least two corresponding ones of the plurality of channels during the concurrent idle times.

14. The communication device of claim 8, wherein the frequency spectrum comprises at least one of:
a licensed frequency spectrum; and
an unlicensed frequency spectrum.

15. A communication device comprises:
a radio frequency (RF) section; and
a baseband processing module, wherein, during an initialization phase, the RF section and baseband processing module function to:
monitor a plurality of channels within a frequency spectrum for transmission patterns;
for a given channel of the plurality of channels:
determine whether a transmission pattern exists; and
when the transmission pattern exists, determine at least one likely communication protocol of a plurality of communication protocols based on at least a portion of the transmission pattern; and
wherein, during an operation phase, the RF section and the baseband processing module function to:
determine an idle time of the given channel based on the likely communication protocol; and
transmit a signal via the given channel during the idle time, wherein the signal is in accordance with a second communication protocol.

16. The communication device of claim 15, wherein at least one of the RF section and the baseband processing module further function to:
utilize the likely communication protocol to obtain access to the given channel.

17. The communication device of claim 15, wherein at least one of the RF section and the baseband processing module further function to:
determine a number of concurrent signals within the frequency spectrum, wherein at least one of the concurrent signals is transmitted via the given channel;
for each of the concurrent signals, determine a center frequency; and
determine, in accordance with the center frequency, an energy pattern of at least a portion of the at least one of the concurrent signals to produce the transmission pattern.

18. The communication device of claim 17, wherein at least one of the RF section and the baseband processing module further function to determine the number of concurrent signals by:
initializing an assumption value;
entering a loop, wherein the loop includes:
determining a sample energy pattern based on an assumption that the concurrent signals includes a number of signals equal to the assumption value or an incremented assumption value;
correlating the sample energy pattern with a plurality of known energy patterns, wherein the plurality of known energy patterns correspond to the plurality communication protocols;
when the sample energy pattern correlates with one of the plurality of known energy patterns, determining the number of concurrent signals equals the assumption value or the incremented assumption value and exiting the loop;
when the sample energy pattern does not correlate with at least one of the plurality of known energy patterns, incrementing the assumption value or the incremented assumption value to produce the incremented assumption value; and
when the incremented assumption value does not exceed a number of channels within the frequency spectrum, repeating the loop based on the incremented assumption value.

19. The communication device of claim 18, wherein at least one of the RF section and the baseband processing module further function to correlate the sample energy pattern with a plurality of known energy patterns by at least one of:
matched filtering the sample energy pattern with the plurality of known energy patterns; and
determining a moving average of magnitude squared of the sample energy pattern with respect to each channel within the frequency spectrum.

20. The communication device of claim 15, wherein at least one of the RF section and the baseband processing module further function to:
determine a plurality of idle times corresponding to the plurality of channels based on a likely communication protocol for each of the plurality of channels;
determine concurrent idle times of at least two of the plurality of idle times; and
transmit a second signal via at least two corresponding ones of the plurality of channels during the concurrent idle times, wherein the signal is formatted in accordance with another communication protocol.
